(19) United States
(12) Patent Application Publication
(10) Pub. No.: US 2012/0008309 A1
(43) Pub. Date: Jan. 12, 2012

(54) Headlamp and Lantern System

(76) Inventor: Eric C. Hale, San Francisco, CA (US)

(21) Appl. No.: 13/152,241

(22) Filed: Jun. 2, 2011

Related U.S. Application Data
(60) Provisional application No. 61/350,915, filed on Jun. 2, 2010.

(51) Int. Cl. F21V 21/084; F21L 4/00

(52) U.S. Cl. 362/105

(57) ABSTRACT

A combination headlamp and lantern adapted to allow multiple uses of the same equipment in a variety of ways. In some aspects, the system performs as a lantern, such as a small lantern which may be used when camping, and which may be used suspended in a tent. In some aspects, the system performs as a headlamp, which may be used worn on the head when walking at night, for example. In some aspects, the lantern is mounted on a tripod.

### CROSS-REFERENCE TO RELATED APPLICATIONS

This application claims priority to U.S. Provisional Patent Application 61/350,915 to Hale, filed Jun. 2, 2010, which is hereby incorporated by reference in its entireity.

### BACKGROUND

### Field of the Invention

The present invention relates to lighting systems, and more specifically to a headlamp and lantern combination system.

### SUMMARY

A combination headlamp and lantern adapted to allow multiple uses of the same equipment in a variety of ways. In some aspects, the system performs as a lantern, such as a small lantern which may be used when camping, and which may be used suspended in a tent. In some aspects, the system performs as a headlamp, which may be used when walking at night, for example.

### BRIEF DESCRIPTION OF THE DRAWINGS

FIG. 1 is an illustration of headlamp worn by a user according to some embodiments of the present invention.

FIG. 2 is an illustration lantern on a tripod according to some embodiments of the present invention.

FIG. 3 is a perspective view of a lantern in a closed configuration to some embodiments of the present invention.

FIG. 4 is a perspective view of a lantern in an open configuration according to some embodiments of the present invention.

FIG. 5 is a perspective view of a lantern in an closed position according to some embodiments of the present invention.

FIG. 6 is an exploded view of a headlamp and lantern system according to some embodiments of the present invention.

FIG. 7 is a side view of a headlamp and lantern system according to some embodiments of the present invention.

FIG. 8 is a cross-sectional view of a headlamp and lantern system according to some embodiments of the present invention.

FIG. 9 is a side perspective view of an LED engine according to some embodiments of the present invention.

FIG. 10 is a top perspective view of an LED engine according to some embodiments of the present invention.

FIG. 11 is a bottom perspective view of an LED engine according to some embodiments of the present invention.

FIG. 12 is a top perspective view of a battery housing according to some embodiments of the present invention.

FIG. 13 is a bottom perspective view of a battery housing according to some embodiments of the present invention.

FIG. 14 is a top view of a battery housing according to some embodiments of the present invention.

FIG. 15 is a side view of a battery housing according to some embodiments of the present invention.

FIG. 16 is a bottom view of a battery housing according to some embodiments of the present invention.

FIG. 17 is a raised perspective view of a lantern with the diffuser extended according to some embodiments of the present invention.

FIG. 18 is a lower perspective view of a lantern with the diffuser extended according to some embodiments of the present invention.

FIG. 19 is a front view of a lantern with the diffuser extended according to some embodiments of the present invention.

FIG. 20 is a side view of a lantern with the diffuser extended according to some embodiments of the present invention.

FIG. 21 is a rear view of a lantern with the diffuser extended according to some embodiments of the present invention.

FIG. 22 is a bottom view of the lantern.

FIG. 23 is a side view of a lantern with a tripod.

FIG. 24 is a front view of a lantern with a tripod.

FIG. 25 is a front view of a headlamp according to some embodiments of the present invention.

FIG. 26 is a side view of a headlamp according to some embodiments of the present invention.

FIG. 27 is a rear view of a headlamp according to some embodiments of the present invention.

FIG. 28 is an end view of a headlamp according to some embodiments of the present invention.

FIG. 29 is a perspective view of a headlamp according to some embodiments of the present invention.

FIG. 30 is an front perspective view of a headlamp according to some embodiments of the present invention.

FIG. 31 is a rear view of a headlamp according to some embodiments of the present invention.

FIG. 32 is a side view of a headlamp according to some embodiments of the present invention.

FIG. 33 is a front view of a user wearing a headlamp according to some embodiments of the present invention.

FIG. 34 is a side view of a user wearing a headlamp according to some embodiments of the present invention.

FIG. 35 is a front view of a tripod.

FIG. 36 is a rear view of a tripod.

### DETAILED DESCRIPTION

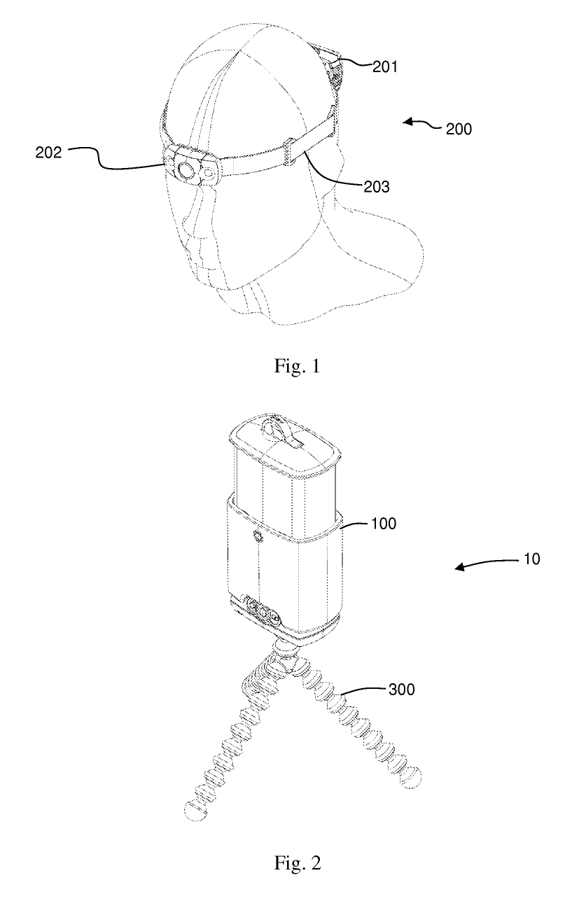

In some embodiments of the present invention, as seen in FIG. 1, the headlamp 200 of the headlamp and lantern system 10 in seen worn by a user. The headlamp LED engine 202 is positioned on the forehead of the user with a strap 203 around the user's head. The battery housing 201 resides at the rear of the user's head, on the strap 203. The headlamp and lantern system 10 is adapted to provide a variety of use options to the user in a compact multi-use design. As seen in FIG. 2, the headlamp and lantern system can also be used as a lantern 100, and may also be mounted to a tripod 300. The same lighting and power components are used in both the headlamp of FIG. 1 and the lantern of FIG. 2.

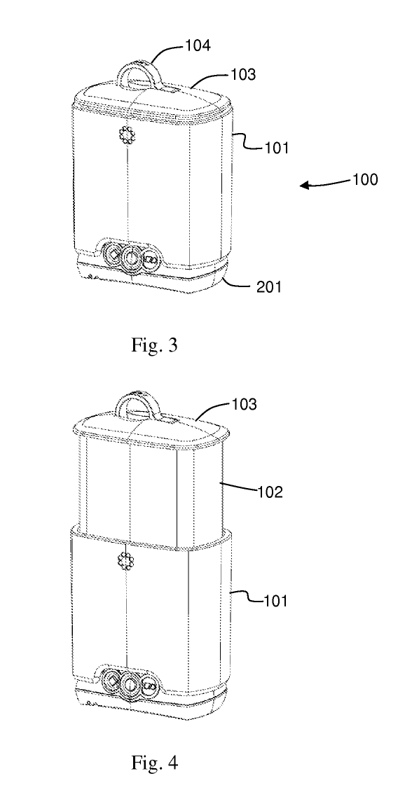

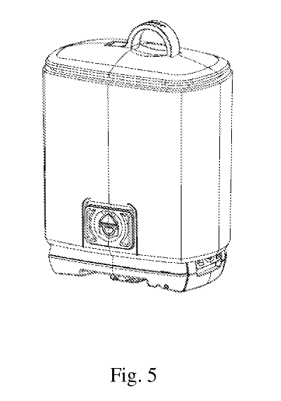

In some embodiments of the present invention, as seen in FIGS. 3, 4, and 5, a lantern assembly 100 is adapted to go from a stowed, more compact, position, as seen in FIGS. 3 and 5, to a deployed position wherein the diffuser 102 is exposed, as seen in FIG. 4. The main lantern housing 101, the diffuser 102, and the lantern top 103 are a part of the system which allows a headlamp to be used to provide the power and light element for a lantern. FIGS. 3 and 5 illustrate the lantern 100 in a stowed position. The diffuser 102 and lantern top 103 have been pushed down into the main housing 101, allowing for compact and more impact resistant storage. The lantern top 103 resides along the top of the main housing 101 in the stowed position. FIG. 4 illustrates the system in an extended position, wherein the system may be used as a lantern. The diffuser 102 and lantern top 103 have been extended up away from the main housing. A deployable hook 104 may deploy from the lantern top 103 to allow for support from above, such as from a hook or a sting.

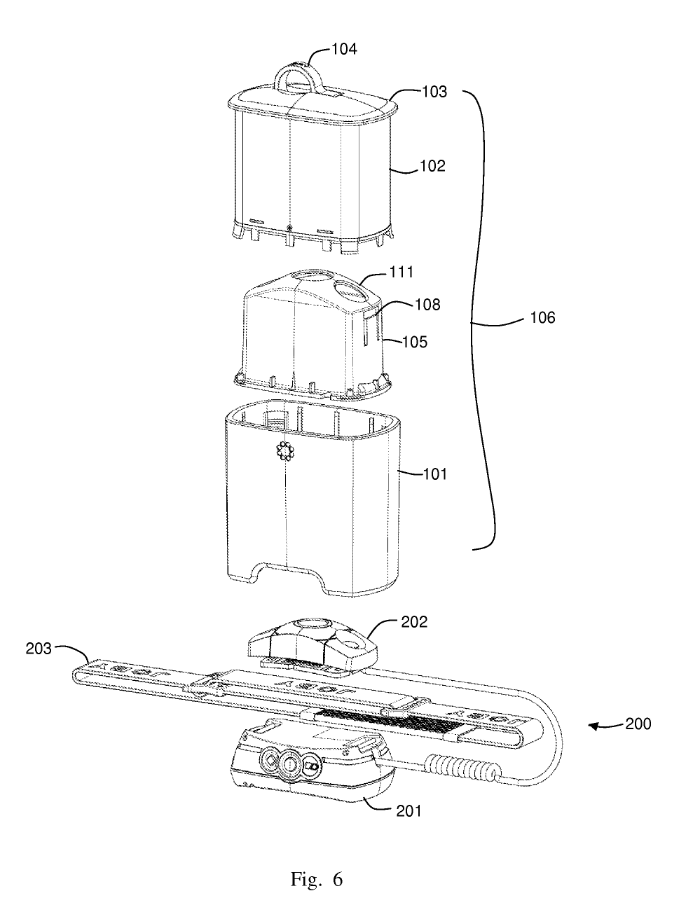

FIG. 6 illustrates portions of the system in exploded view. The removable lantern portion 106 is adapted to receive the headlamp portion 200 to be used a functioning lantern. The removable lantern portion 106 may have an outer housing 101 and an inner housing 105 which is affixed to the outer housing. The outer housing 101 and the inner housing 105 may define a space in between in which the diffuser 102 resides when in the stowed position. The stowing of the diffuser may allow for protection of the diffuser when the assembly is not in use as a lantern, and also allow for a more compact storage of the assembly. The diffuser 102 is adapted to be able to deploy to an extended position and then have mechanical stops that limit further travel. The top of the inner housing may have a reflector 111 adapted to reflect light within the diffuser to be reflected away. Clips 108 may be present to gently capture the headlamp LED engine 202 when inserted into the inner housing 105. The clips 108 may capture the edge of the LED engine 202 along a bottom edge. When in use as a lantern, the LED engine 202 may be inserted into the inner housing 105 and captured with the clips 108. The strap 103 may then be inserted into the inner housing 105 below the LED engine 202, and the battery housing 201 may the clip into the bottom of the lantern portion 106. With the deployable portion of the lantern portion 106 stowed, and the headlamp 200 inserted into and clipped into the lantern portion 106, a compact unit is created for storage of this multi-function apparatus.

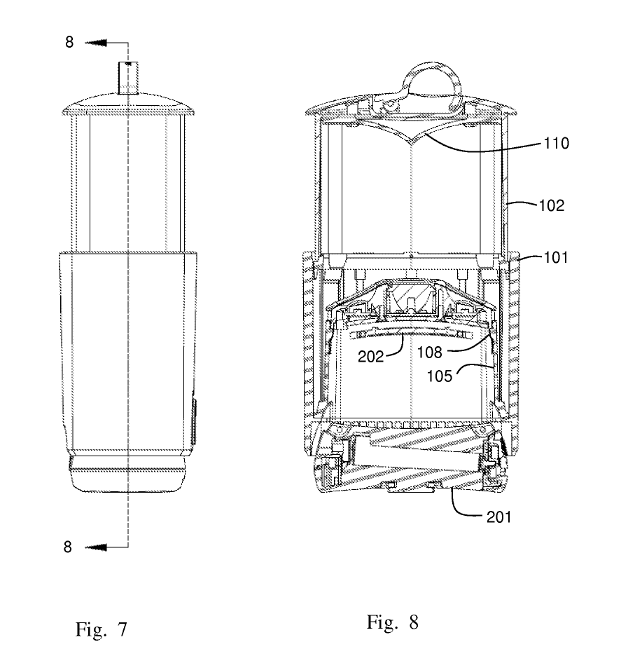

In some embodiments of the present invention, as seen in FIGS. 7 and 8, the lantern assembly is seen with the LED engine 202 clipped into the inner housing 105 using clips 108. An upper reflector 110 is adapted to reflect light outward towards the diffuser 102. The upper reflector 110 may be electroplated polycarbonate in some embodiments. The plating may be aluminum or indium tin oxide in some embodiments.

When the diffuser and lantern top are moved to the extended position, the head lamp which resides in the upper portion of the inner housing provides light up into the diffuser. Within the top of the diffuser is a reflector, which is adapted to reflect light back down within the diffuser. Above the head lamp is a secondary reflector, also adapted to deflect light. The lights of the headlamp lamp, which may be LEDs in some embodiments, are adapted to shine through holes in the secondary reflector and up into the diffuser area. At the top of the diffuser resides the main reflector.

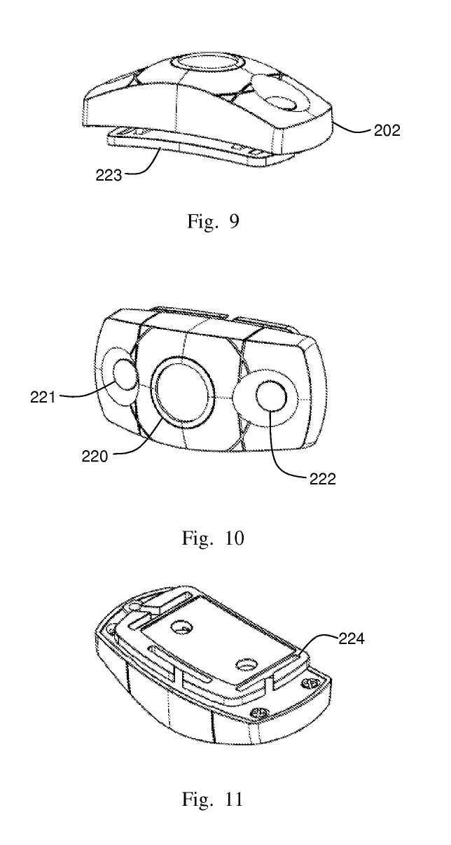

FIGS. 9-11 illustrate the LED engine 202 according to some embodiments of the present invention. The center light 220 may be a 130 lumen white LED. The side lights 221, 222 may each have a red LED and a white LED in some embodiments. The center light may be used for spot lighting, and the side lights for flood lighting in some embodiments. Power for the LED engine is routed from the battery housing with a wire along the strap. The is adapted to stretch along with the strap when worn by a user. The base 223 of the LED engine 202 may have slots 224 adapted to receive the strap. The LED engine may be adapted to rotate in that the direction of the lights may be adjusted relative to the base 223. This may allow for directional adjustment of the light beam when worn as a headlamp.

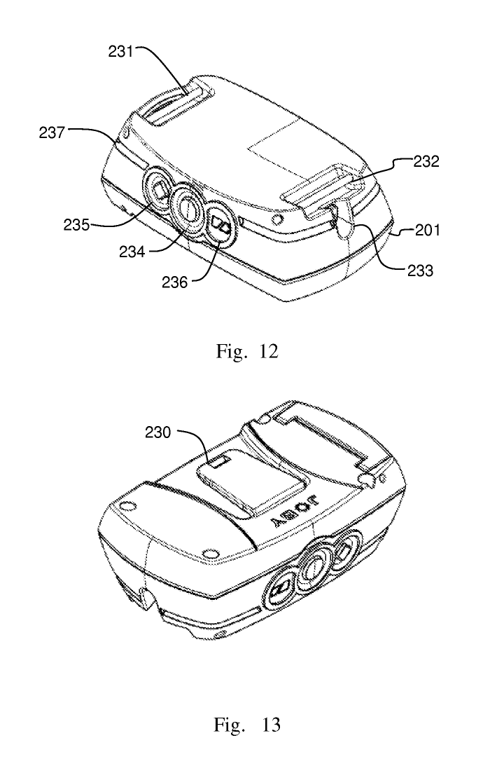

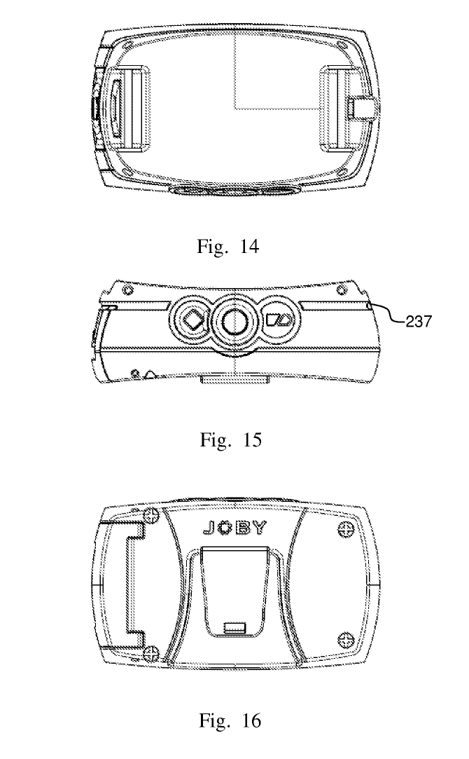

FIGS. 12-16 illustrate the battery housing 201. The strap of the headlamp is adapted to utilize junctions 231, 232 for connection to the battery housing. A slot 233 is used to route the wire out of the battery housing 201 and to the LED engine. On the bottom of the battery housing, a clip 230 may be present which is adapted to clip into a support structure such as a tripod. A slot 237 is adapted for use with tabs in the lantern housing which facilitate the retention of the battery housing in the lantern housing. Switches 234, 235, 236 are adapted to operate the LEDs.

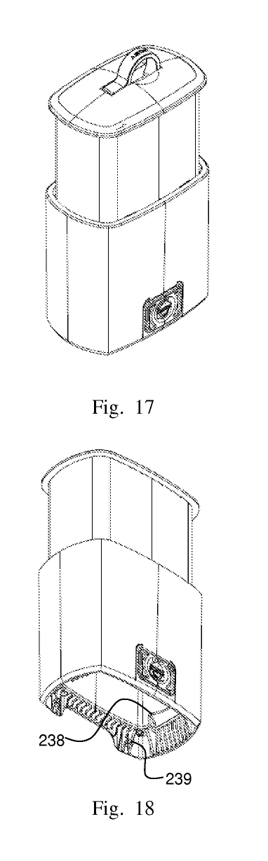

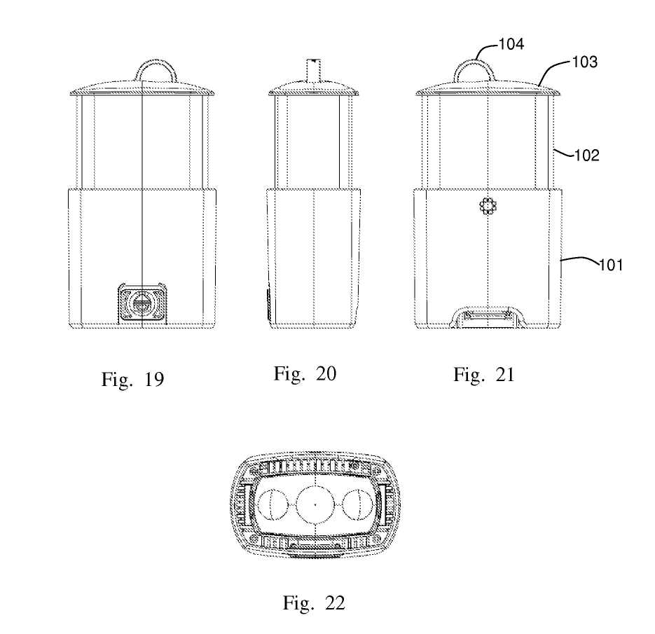

FIGS. 17-22 illustrate the lantern portion 106 according to some embodiments of the present invention. A lip 238 may be present on each end and may be adapted to capture the battery housing along its slots 237. Tabs 239 are present and adapted to capture the bottom of the battery housing. The operational buttons of the battery housing are adapted to be accessible when the battery housing is in the lantern portion.

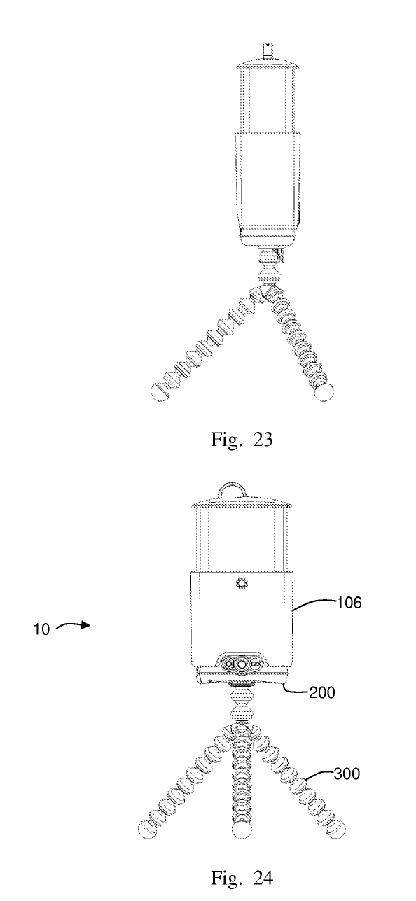

FIGS. 23 and 24 illustrate a use of the lantern with a flexible tripod as a headlamp and lantern system 10. In some embodiments the bottom of the battery housing may have an integral clip feature adapted to clip into a support structure such as a flexible tripod. In some embodiments, the tripod may be magnets at the ends of its flexible legs.

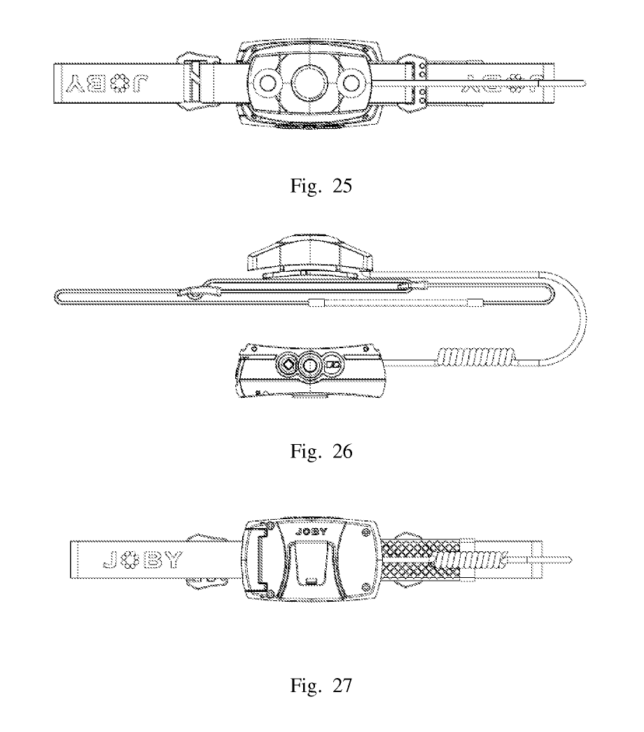

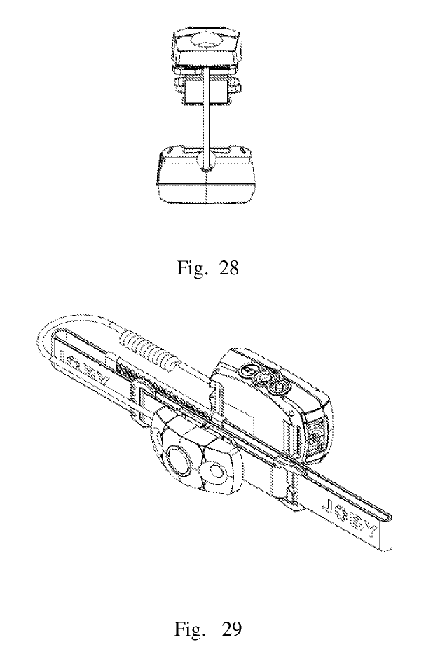

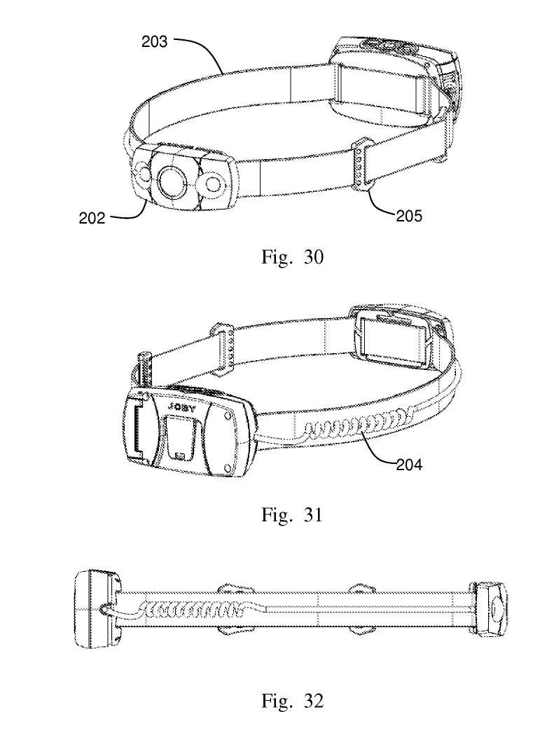

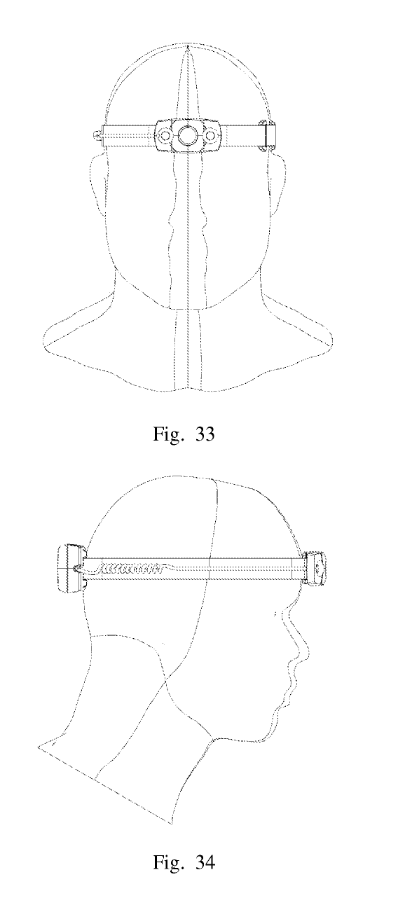

FIGS. 25-29 illustrate the headlamp portion with the battery housing not fully incorporated for example only. FIGS. 30-32 illustrate the headlamp as it would be worn by a user. A wire or set of wires 204 routes power from the battery housing 201 to the LED engine 202 along the strap 203. Use of the headlamp on a head of a user is illustrated in FIGS. 33 and 34. The battery housing will reside at the rear of the user's head in some embodiments. The electrical power for the headlamp portion will travel through conductors from the battery housing. In some embodiments, the conductors will reside within the elastic band and be adapted to allow for extension of the elastic band.

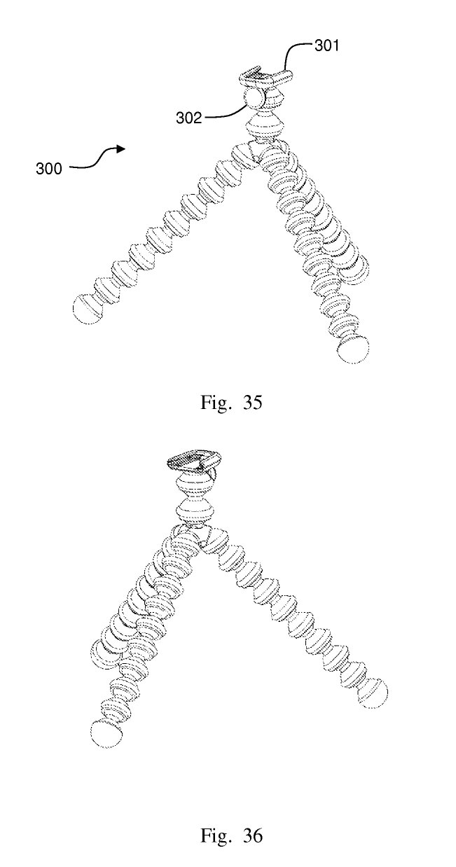

FIGS. 35 and 36 illustrate a tripod which may be used as a support structure in some embodiments of the present invention. The tripod 300 may have a clip receiver 301 adapted to receive the clip 230 on the bottom of the battery housing 201 to complete a headlamp and lantern system 10. The tripod 300 may have flexible legs with frictional gripping portions on their exterior adapted to wrap around items such as bars and poles in some embodiments.

The present invention has been particularly shown and described with respect to certain preferred embodiments and specific features thereof. However, it should be noted that the above-described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims. Also, reference in the claims to an element in the singular is not intended to mean “one and only one” unless explicitly stated, but rather, “one or more”. Furthermore, the embodiments illustratively disclosed herein can be practiced without any element which is not specifically disclosed herein.

What is claimed is:

1. A headlamp and lantern system comprising:
a headlamp portion, said headlamp portion comprising:
a lamp portion;
a battery portion; and
a headband portion, said headband portion linking said lamp portion and said battery portion along a continuous head band adapted to be worn around the head of a user; and
a lantern portion, wherein said headlamp portion is adapted to removeably attach to said lantern portion to create a lantern.

2. The headlamp and lantern system of claim 1 wherein said lantern portion comprises a diffuser, and wherein said lamp portion of said headlamp portion is mounted within said lantern portion such that said lamp portion illuminates said diffuser when said lantern portion is attached to said headlamp portion.

3. The headlamp and lantern system of claim 2 wherein said lantern portion further comprises an extendable lantern housing, and wherein said diffuser resides within said extendable lantern housing in a first stowed position, and wherein said diffuser is outside of said extendable lantern housing in a second deployed position.

4. The headlamp and lantern system of claim 1 wherein said headlamp portion is attached to said lantern portion such that said battery housing is a bottom surface of said system.

5. The headlamp and lantern system of claim 4 further comprising a tripod, wherein said tripod is releasably attached to said battery housing.

6. The headlamp and lantern system of claim 5 wherein said battery housing comprises a clip, and wherein said tripod comprises a clip receiver adapted to releasably receive said clip.

7. The headlamp and lantern system of claim 2 wherein said diffuser comprises a two dimensional holographic lens.

8. The headlamp and lantern system of claim 3 wherein said extendable lantern housing comprises:
an outer housing;
an inner housing within in said outer housing defining a space between said inner housing and said outer housing; and
a diffuser, wherein said diffuser is adapted to extend from a first position within said space to a second position outside of said space.

9. The headlamp and lantern system of claim 8 further comprising a lantern top, said lantern top mounted on the top of said diffuser.

10. The headlamp and lantern system of claim 9 wherein said top mounts on the top of said outer housing when said diffuser is in said first position.

11. The headlamp and lantern system of claim 10 wherein said lantern top comprises a hook on its top surface.

12. The headlamp and lantern system of claim 11 wherein said diffuser comprises a hollow structure of holographic lens material.

13. The headlamp and lantern system of claim 12 further comprising a reflector underneath said lantern top, said reflector adapted to reflect light out through said diffuser.

14. The headlamp and lantern system of claim 8 wherein said lamp portion attaches to said inner housing of said extendable lantern housing.
